(19) United States
(12) Patent Application Publication
(10) Pub. No.: US 2005/0162819 A1
(43) Pub. Date: Jul. 28, 2005

(54) Calculator

(76) Inventor: Lobo Wang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/763,193

(22) Filed: Jan. 26, 2004

(51) Int. Cl. G06F 1/16

(52) U.S. Cl. 361/681

(57) ABSTRACT

The present invention is a calculator that comprises a body, a couple device and a display unit. The body has several press groups placed on its one side and a display containing space placed on the other side which used for containing the display unit. The display unit comprises a main panel and an assistant panel. The main panel and the assistant panel are placed on two joint planes. The couple device joining the body and the display unit allows the display unit rotate around the couple device Users can make the display unit to stay on open status and closed status by pushing the display unit. The present calculator shows calculating information to users opposite each at the same time.

### FIELD OF THE INVENTION

The present invention relates generally to a calculator and more particularly to a calculator which displays calculating information in two direction at the same time.

### BACKGROUND OF THE INVENTION

People use calculator in various situation. Usually, the calculator equips with only one panel that faced with the handler, and only the handler can see calculating status. But in many situations, such as financial department, shop, etc., others have the same requirement to find out the calculating procedure and results as quickly as possible. Under such situation, for the handicap caused by counter or table, the handler will get the calculating results and then show it to others. Therefore, the people opposite the handler can't know the result in real-time. It is adverse for people finding errors, enhancing trust and efficiency.

Thereafter, a calculator equipped with two panels are disclosed. A protuberant part that shaped as a triangle are placed on the surface of the calculator, and the protuberant part has two panels placed on its two inclined plane so that displaying calculate procedure and result in two direction. However, this design will increase the calculator volume, and users can't carry it expediently. Furthermore, the two panels placed on the protuberant part are easily damaged.

### SUMMARY OF THE INVENTION

An object of the present invention is to provide a calculator so as to show calculating procedure and results in two direction at the same time, and the calculator has compact construct so as to carry expediently.

In order to achieve the above object, the present invention provides a calculator comprising a body, which has several press groups placed on its one side and a containing space placed on the other side which used for containing the display unit; a display unit, which comprises a main panel and an assistant panel which are placed on two joint planes; and a couple device used for joining the body and the display unit and making the display unit rotate around it. While the display unit rotates upwards and then stay on open status, the main panel and the assistant panel will keep a fit angle on the body so that the handlers and other users opposite to the handlers can find out the calculating information at the same time. While the display unit rotates downwards and then stays on closed status, the display unit will be contained in the body and the main panel will be essentially level with the body surface, the assistant panel will be embedded in the body.

In order to achieve the above object, the couple device of the present invention comprises a pivot, the containing space has a pair of containing holes placed on its two sidewalls. The display unit has a locating hole penetrating the display unit placed between two sidepieces. The locating hole and the containing holes are paired used for containing the pivot, so that the pivot connects the display unit with the body reelingly.

In order to achieve the above object, the couple device of the present invention comprises a pair of pivots which are placed on two side of the display unit. The containing space has a pair of containing holes placed on its two sidewalls. The display unit has two locating hole placed on its two sidepieces respectively. The locating holes and the containing holes are paired so as to locate the two pivots. Two ends of each pivot will correspondingly be contained in the locating holes and the containing holes, so that the pivot connects the display unit with the body reelingly.

As described above, the present invention will display calculating information in two direction, and the calculator has compact construct so as to carry expediently.

### BRIEF DESCRIPTION OF THE DRAWINGS

The present invention will be apparent to those skilled in the art by reading the following description of preferred embodiments thereof, with reference to the attached drawings, in which:

FIG. 1 is an exploded view of a preferred embodiment of the present invention;

FIG. 2 is a perspective view of the preferred embodiment of the present invention showing the display unit stayed on open status;

FIG. 3 is a perspective view of the preferred embodiment of the present invention showing the display unit stayed on closed status;

FIG. 4 is an exploded view of the second preferred embodiment of the present invention.

### DETAILED DESCRIPTION OF PREFERRED EMBODIMENTS OF THE INVENTION

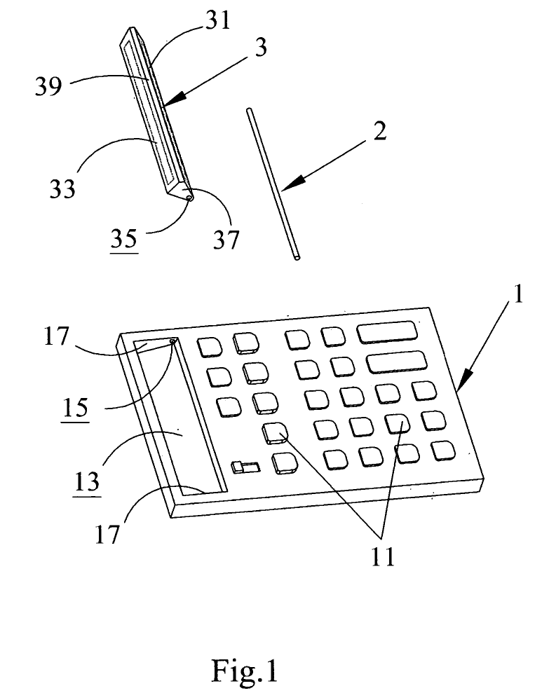

Please refer to FIG. 1, a calculator of the present invention comprises a body 1, a couple device and display unit 3, the couple device will connect the body 1 with the display unit 3 so that the display unit 3 rotates in an angle in the body 1. The couple device of the first embodiment is a pivot 2.

The body 1 has several press groups 11 placed on its one side and a containing space 13 placed on the other side which used for containing the display unit 3. The containing space 13 has a pair of containing holes 15 placed on its two sidewalls 17 for containing the pivot 2.

The display unit 3 comprises a main panel 31 and an assistant panel 33. The main panel 31 which faces the press group 11 provides calculating information to handler The assistant panel 33 provides calculating information to other users except for handler. The main panel 31 and the assistant panel 33 are placed on two planes that are converged. The main panel 31 and the assistant panel 33 are back to back. A push part 39 is located between the main panel 31 and the assistant panel 33 so as to help users rotating the display unit 3. The display unit 3 has a locating hole 35 placed between two sidepieces 37. The locating hole 35 and the containing holes 15 are paired so that the pivot 2 connects the display unit 3 with the body 1.

The pivot 2 penetrates through the locating hole 35. Two end of the pivot 2 will be contained in the two containing holes 15, so that the display unit 3 are joined with the body 1 and the display unit 3 will rotate around the pivot 2.

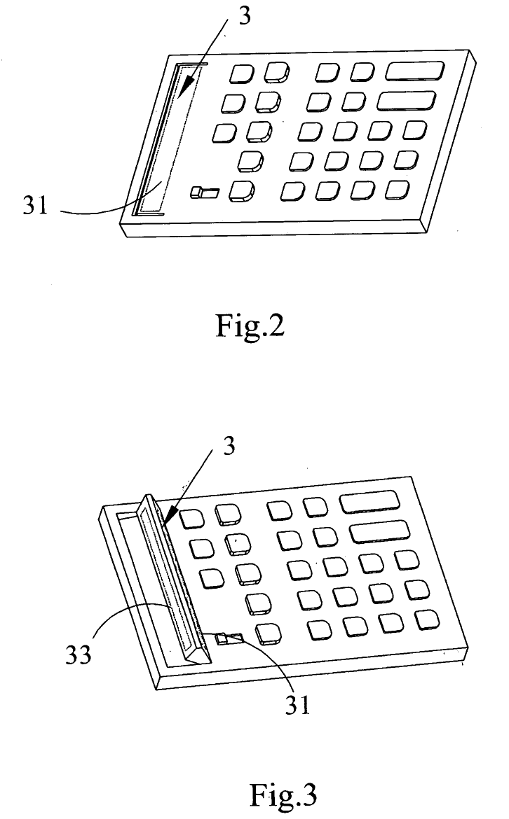

If the handlers and customs want to find out the calculating information at the same time when the handlers will push the push part 35, the display unit 3 rotates upwards and stays on open status, as shown in FIG. 2. Under the open status, the main panel 31 and the assistant panel 33 keeps a fit angle on the body 1 so that the handlers and other users opposite the handlers can find out the calculating information at the same time. When the operation completed, the handlers push the display unit 3 in reverse. The display unit 3 rotates downwards and stays on closed status, as shown in FIG. 3. Under the closed status, the display unit 3 is contained in the body 1 and the main panel 31 is essentially level with the body 1 surface. The assistant panel 33 is embedded in the body 1. Furthermore, the calculator can also be used while the display unit 3 stayed on closed status.

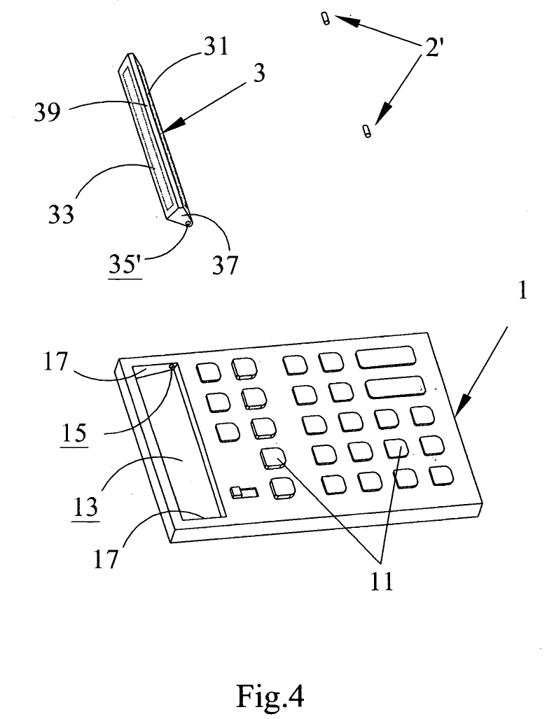

Please refer to FIG. 4. FIG. 4 shows another embodiment of the present invention. In this embodiment, the calculator comprises a pair of pivots 2′. Each sidepiece 37 of the display unit 3 has a locating hole 35′. The locating hole 35′ and the containing holes 15 are paired so as to locate the two pivots 2′. Two ends of each pivot 2′ are correspondingly contained in the locating holes 35′ and the containing holes 15, so that the display unit 3 is joined to body 1 and the display unit 3 can rotate around the pivot 2.

Other circuits such as display circuit, calculating circuit and so on, are not the characteristic of the present invention and have been disclosed, so they are not describe in this invention.

This invention has been described with reference to specific embodiments, this description is not to be construed in a limiting sense. For example, those skilled in the art will recognize modifications and alterations that may be made to the embodiments illustrated herein. However, it is contemplated that such modifications can be made without departing the scope and spirit of the invention as defined in the following claims. For example, to integrate the pivot with the body or the display unit and then to pair with the containing holes or locating holes should be the claim scope of the present invention.

1. A calculator comprising:
a body having several press groups placed on its one side and a containing space placed on the other side for containing the display unit;
a display unit comprising a main panel and an assistant panel, the main panel and the assistant panel being placed on two joint planes; and
a couple device joining the body and the display unit and allowing the display unit rotate around the couple device;
while the display unit rotates upwards and stays on open status, the main panel and the assistant panel keep a fit angle on the body so that the handlers and other users opposite to the handlers find out the calculating information at the same time; while the display unit rotates downwards and stays on closed status, the display unit is contained in the body and the main panel is essentially level with the body surface.

2. The calculator as claimed in claim 1, wherein the couple device comprises at least a pivot, the containing space has a pair of containing holes placed on its two sidewalls, and the display unit has a locating hole penetrating the display unit placed between two sidepieces, the locating hole and the containing holes are paired for containing the pivot, so that the pivot connects the display unit with the body.

3. The calculator as claimed in claim 1, wherein the couple device comprises a pair of pivots which are placed on two side of the display unit, the containing space has a pair of containing holes placed on its two sidewalls, and the display unit has two locating hole placed on its two sidepieces respectively, the locating holes and the containing holes are paired so as to locate the two pivots, two ends of each pivot are correspondingly contained in the locating holes and the containing holes, so that the pivot connects the display unit with the body.

4. The calculator as claimed in claim 1, wherein a push part is located between the main panel and the assistant panel for rotating the display unit.
